(19) United States
(12) Patent Application Publication
(10) Pub. No.: US 2019/0250330 A1
(43) Pub. Date: Aug. 15, 2019

(54) METHOD FOR IMPLEMENTING AND ATTACHING STRUCTURE-INTEGRATED OPTICAL WAVEGUIDES

(71) Applicant: Airbus Defence and Space GmbH, Taufkirchen (DE)

(72) Inventors: Matthias FUNKE, Markdorf (DE); Jonathan DRAPER, Inverness (GB); Jürgen MEILINGER, Wolnzach (DE); Maria GRUBER, Baar-Ebenhausen (DE); Manuela SÜSS, Kluftern (Friedrichshafen) (DE); Thomas ROTH, Reutlingen (DE)

(21) Appl. No.: 16/275,510

(22) Filed: Feb. 14, 2019

(30) Foreign Application Priority Data
Feb. 15, 2018 (DE) 10 2018 103 452.0

(51) Int. Cl. G02B 6/132; F21V 8/00

(52) U.S. Cl. CPC G02B 6/132; G02B 6/0006; G02B 6/0033

(57) ABSTRACT

A method for implementing and attaching at least one structure-integrated optical waveguide in a laminate component. In the method, at least one optical waveguide is introduced at a predetermined position during a laying procedure of a laminate to produce a laminate component. Furthermore, the laminate component is finished, wherein the optical waveguide is completely enclosed by the laminate. Furthermore, at least one end of the optical waveguide is exposed. Furthermore, a coupling component is attached to the at least one exposed end.

### CROSS-REFERENCE TO RELATED APPLICATION

This application claims priority to German Application DE 10 2018 103 452.0 filed Feb. 15, 2018, the entire disclosure of which is incorporated by reference herein.

### TECHNICAL FIELD

Various embodiments relate in general to a method for implementing and attaching structure-integrated optical waveguides in laminates.

### BACKGROUND

It has heretofore not been possible to equip laminate components or composite structural components of arbitrary industries with structure-integrated sensor and/or communication fibers and to integrate the optical interfaces required for this purpose reliably in the production process, without these influencing the production process excessively strongly or the risk existing of damaging the fibers in the production process. Such fittings are required, on the one hand, to enable wear-free and integrated solutions for communication in composite components, and/or to check these composite components with the aid of the same fibers for strain, appearances of aging, fracture, deformation, temperature distribution, or acoustically. This applies to composite components during the integration, and to the measurement during the entire service life. The reasons for this are manifold, but lie primarily in the problems of the plug attachment and in the integration of the fibers into the material itself. The mechanical integrity of the produced structure and possibly its stability and strength are influenced. Moreover, no standard plugs are available on the market which can be integrated during the production of the material, because of the production process of the composite structure.

### SUMMARY

Proceeding therefrom, it is an object of the disclosure herein to provide an improved method for integration of an optical waveguide into a laminate.

This object is achieved by a method having features disclosed herein. Exemplary embodiments are described herein. It is to be noted that the features of the exemplary embodiments of the devices also apply to embodiments of the method and the use of the device and vice versa.

The object is achieved by a method for implementing and attaching at least one structure-integrated optical waveguide in a laminate component. In the method, at least one optical waveguide is introduced at a predetermined position during a laying procedure of a laminate for producing a laminate component. Furthermore, the laminate component is finished, wherein the optical waveguide is completely enclosed by the laminate. Furthermore, at least one end of the optical waveguide is exposed. Furthermore, a coupling component is attached to the at least one exposed end.

The disclosure herein is based on the concept of introducing, for example, by way of a high-precision robot, an optical waveguide, for example a communication and/or sensor fiber, during the production process of a laminate into the structure and storing the exact position of the fiber in the structure for later use. After this step, the laminate or the composite structure is finished according to the known method. After finishing of the structure, for example, at any arbitrary access point to the fiber, it is exposed by drilling, for example. The fiber end thus exposed is now specially treated. The fiber end, which is thus end-treated and located with high precision, now receives a further component, which is introduced in or at the access point (for example, the borehole). This component has the task of deflecting the light beam out of the component or into the component from or to the fiber, respectively. More precisely, the classic production process of the laminate structure is maintained unchanged after introduction of the optical waveguide and the final material properties are produced after the curing, for example, in an autoclave. The final contour of the component or the component structure is produced in consideration of the known position of the waveguide in the laminate by standard machining processes. After finishing of the laminate component, at least one end of the optical waveguide is exposed by milling or the use of a laser ablation process. Furthermore, the exposed end of the optical waveguide is prepared, and a coupling component is attached to the prepared end of the optical waveguide and fixedly connected to the structure.

The term laminate or is to be understood to include all types of materials which consist of or comprise two or more bonded materials, wherein the laminate or the composite material has different material properties than its individual components. A laminate can be, for example, a composite material or bonded material. The laminate can consist of or comprise, for example, fiber composite materials, which consist of or comprise glass fibers or carbon fibers, for example, and are impregnated using a resin system and consolidated by curing, for example. Alternatively, the laminate can comprise further composites, for example, based on metallic and ceramic materials.

The term predetermined position is to be understood as the most accurate possible course of the optical waveguide in the laminate component, which enables unambiguous retrieval of the preferably complete optical waveguide in the laminate component. The predetermined position comprises, for example, preferably for the complete length of the optical waveguide, the accurate position within the laminate component. This has the advantage that in the case of additional milling grooves and boreholes, which are introduced later into the component, for example, the accurate location of the optical waveguide is known. The optical waveguide is preferably guided around such boreholes and milling grooves to be added later. Moreover, it is also advantageous if the accurate position of the sensors, i.e., for example, the Bragg gratings in the optical waveguide, are known, in order to know later in which region within the laminate component the detected region is located.

The term optical waveguide or light guide is to be understood as any type of transparent components, for example fibers, tubes, or rods, which are capable of transporting light over short or long distances, wherein the light guiding is achieved by reflection at the boundary surface of the light guide either by total reflection because of a low index of refraction the medium surrounding the light guide or by mirroring of the boundary surface. The optical waveguide can be provided in this case, for example, as a multimode fiber or as a single-mode fiber.

The term position of the optical waveguide is to be understood as any position specification of at least one end or a section of the optical waveguide which is sufficient to accurately determine the accurate position of an exposed end of the optical waveguide. The position information additionally also contains the information about the depth at which, that is to say between which layers of the laminate, the waveguide is located.

The term exposure of at least one end of the optical waveguide is to be understood as any type of exposing of at least one end of the optical waveguide, wherein at least the cross-sectional area of the optical waveguide is exposed and thus made accessible. The exposure is however also to be understood as an exposure of the at least one end which also comprises still further regions of the at least one end of the optical waveguide in addition to at least the cross-sectional area.

When reference is made in the context of this disclosure to light, this is thus to be understood to include electromagnetic waves in general, which may be conducted by optical media. A restriction to the light visible to the human eye is not intended. Since the water intercalated in the quartz glass disproportionally damps light at specific frequencies, in optical waveguides it will for example be in ranges which are preferably between the frequency peaks of water. Typical wavelength ranges which are used in this case are, for example, between approximately 790 nm and approximately 900 nm, around the range of 1300 nm, or around the range between 1500 nm and 1600 nm.

According to one embodiment of the method, the exposure of at least one end of the optical waveguide is performed by laser, drilling, or milling. Alternatively, the exposure of at least one end can also be performed by a chemical method, for example, etching, or by the use of a laser or other methods, which are capable of exposing at least one end of the optical waveguide. An opening, depression, or a passage through the material component is advantageously created for this purpose. The at least one end of the optical waveguide is preferably severed during the exposure. A cut edge or cross-sectional area results in this case at the end of the optical waveguide, which can be prepared thereafter, for example. Alternatively, the exposure can also be performed without or with only minimal damage to the optical waveguide. This has the advantage that the optical waveguide can be contacted from the outside.

According to one embodiment of the method, the at least one end of the optical waveguide to be exposed is enclosed by a protective envelope. The protective envelope can be at least partially opened or removed after the exposure of the at least one end. The end of the optical waveguide to be exposed is enclosed in this case, for example, in a protective envelope made of plastic, metal, or other materials or material combinations or multiple protective envelopes, which protect at least the ends of the optical waveguide during the production of the laminate. For example, the at least one end enclosed by a protective envelope can be provided in linear, rolled, wound, looped, or other forms. Alternatively, the entire optical waveguide, i.e., over the entire length, can also be enclosed by a protective envelope.

According to one embodiment, is the at least one exposed end of the optical waveguide is prepared. To enable an optimum optical connection to the optical waveguide, it can be advantageous to prepare the exposed end, i.e., at least the exposed cross-sectional area of the exposed end.

According to one embodiment of the method, the preparation of the at least one end of the optical waveguide is performed by polishing or grinding. Alternatively, the preparation of the end of the optical waveguide can also be carried out by any other method which is suitable for preparing the end of the optical waveguide for further use, for example, the connection of the coupling component. For example, the preparation can also be performed chemically, mechanically, thermally, or also optically, for example, by a laser. This has the advantage that the prepared end of the optical waveguide preferably does not cause any interference or quality losses of a light beam guided in or out.

According to one embodiment of the method, the coupling component is configured to conduct a light beam introduced into the end of the optical waveguide into and/or a light beam guided out of the end of the optical waveguide out of the laminate component. A mirror, which is capable of introducing a light beam into the previously prepared end of the optical waveguide or guiding it out therefrom, can be used, for example, as the coupling component, or also as an optical receiver and/or transmitter component. It is advantageous in this case if the coupling component is capable of changing the beam direction of a light beam with respect to at least one orientation. This has the advantage that, for example, the direction of incidence and/or the direction of emission does not have to be provided in the same two-dimensional or three-dimensional orientation as the end of the optical waveguide or the optical waveguide itself.

According to one embodiment of the method, the coupling component is configured to change the shape of the light beam by beam shaping. To ensure an interference-free function, this component can also be used for the purpose of forming the exiting or entering light in the sense of beam shaping in a way which corresponds to the system requirements. The term beam shaping is to be understood as any type of beam forming. Beam shaping or beam forming can be performed, for example, by one or more lenses or lens systems. This has the advantage that a desired application-optimized beam geometry of the light incident in the optical waveguide or emitted therefrom can be performed.

According to one embodiment of the method, the coupling component is permanently fixed to the laminate component. As soon as the coupling component is positioned in or at the borehole or opening with the exposed end of the optical waveguide, it is fixed in this position. A secure connection and position in relation to the exposed end of the optical waveguide is ensured by this fixing on the laminate component.

According to one embodiment of the method, the fixing is performed by a screw connection, clamping, and/or adhesive bonding. The component is permanently or detachably fixed on the laminate component by the screw connection, clamping, or adhesive bonding. Permanent fixing has the advantage that the relative position of the coupling component to the exposed end of the optical waveguide is nearly constant. With detachable fixing, for example, the coupling component can be replaced more easily. The connection advantageously has both advantages.

According to one embodiment of the method, the predetermined position of the at least one optical waveguide comprises the orientation of the optical waveguide in the laminate component. The term orientation is to be understood as the alignment of the optical waveguide in the two-dimensional or three-dimensional direction in combination with the depth information direction with respect to the material component.

According to one embodiment of the method, the method furthermore has the step of attaching a connecting element to the coupling component. A plug or adapter, which is capable of optically connecting the coupling component, for example, to a measuring device to be attached, can be understood as the connecting element.

According to one embodiment of the method, the connecting element is an optical plug. A plug is preferably attached or applied at the position of the exiting or entering light on the surface of the composite structure. An optical plug is to be understood as any optical waveguide connecting element which is capable of providing an optical signal transmission. For example, the connecting element is part of an optical waveguide plug connection. The connecting element preferably has the lowest possible signal damping or insertion loss and a high return loss. The connecting element is preferably capable of ensuring a high level of reproducibility and/or maintaining these parameters over several hundred connection cycles.

According to one embodiment of the method, the connecting element has a device for widening a light beam. This can also contain, for example, so-called expanded beam technologies, to guarantee a high-quality reproduction of the light signal. The device is preferably capable of enabling an enlargement of an optical beam diameter. This is desirable, for example, to also be able to illuminate larger objects using generally very thin laser beams. The widening can be achieved, for example, by various optical lens systems. For example, the widening can be performed by a telescopic system in inverted Kepler arrangement or inverted Galileo arrangement.

According to one embodiment of the method, the optical waveguide is a sensor and/or communication fiber. A sensor fiber is to be understood as an optical waveguide or light guide which has at least one sensitive section or reference section. Portions of the sensor fiber having, for example, a limited length viewed in the longitudinal alignment of the sensor fiber, which cause an optical sensitivity of the sensor fiber, are referred to as the sensitive section or reference section.

For example, the bending of a component may be determined via the elongation measurement in the x and y directions and of the corresponding correlation of the depth of the structure at which these elongations can occur.

Alternatively, a surface treatment can also be used for the targeted increase of losses during the transmission of the measurement light through the sensor fiber. A bending sensitivity of the sensor fiber may be achieved, for example, if the sensitive section is only applied on one side of the circumference of the sensor fiber (the extension of the lateral surface formed by the sensor fiber is to be understood as the circumference, wherein the sensor fiber does not necessarily have to have a circular cross section). This has the advantage that, for example, twists or movements within the structure of a laminate component can be easily detected.

According to one embodiment of the method, the optical waveguide has a fiber Bragg grating, which forms a mechanical and/or optical sensor. The term fiber Bragg grating is to be understood to include optical interference filters inscribed in optical waveguides. Wavelengths which are within the filter bandwidth around λB are reflected in this case. For this purpose, for example, a section of the optical waveguide consists of or comprises multiple subsections (for example, having a length λ/2=∧). The length ∧ is preferably composed in this case of two λ/4 parts, which differ in the index of refraction. A part of the supplied amplitude is reflected by Fresnel reflection (Fresnel formula (perpendicular incidence)) at each boundary surface. The periodic change of the index of refraction and/or the wave impedance causes, for example, the reflected wave to experience a phase jump of either 0° or 180° at the end of each λ/4 part. Constructive interference in the reflected wave can occur, for example, due to multiple reflection.

The object is furthermore achieved by a laminate component which has at least one optical waveguide. The optical waveguide is completely embedded in the laminate component. The laminate component has at least one coupling component. The coupling component is at least connected to an exposed end of the at least one optical waveguide. The coupling component is fixedly connected to the laminate component.

### BRIEF DESCRIPTION OF THE DRAWINGS

In the drawings, identical reference signs generally refer to identical parts over the various views. The drawings are not necessarily to scale; importance is generally instead placed on the illustration of the principles of the disclosure herein. Various embodiments of the disclosure herein are described in the following description with reference to the appended, example drawings, in which:

FIG. 1 shows a flow chart for an embodiment of the method;

FIGS. 2A-2F show individual method steps in detail;

FIG. 3 shows an embodiment of a laminate component having integrated optical waveguide; and

FIG. 4 shows a further embodiment of a laminate component having integrated optical waveguide.

### DETAILED DESCRIPTION

The following detailed description refers to the appended drawings, which show specific details and embodiments for explanation, in which the disclosure herein can be practiced.

The word “for example” is used herein with the meaning “serving as an example, case, or illustration”. Any embodiment or design which is described herein as “for example” is not necessarily to be interpreted as preferred or advantageous in relation to other embodiments or designs.

In the following detailed description, reference is made to the appended drawings, which form a part of this description and in which specific embodiments are shown for illustration, in which the disclosure herein can be exercised. It is apparent that other embodiments can be used and structural or logical changes can be made without deviating from the scope of protection of the disclosure herein. It is apparent that the features of the various exemplary embodiments described herein can be combined with one another, if not specifically indicated otherwise. The following detailed description is therefore not to be interpreted in a restrictive meaning, and the scope of protection of the disclosure herein is defined by the appended claims. In the figures, identical or similar elements are provided with identical reference signs, if this is reasonable.

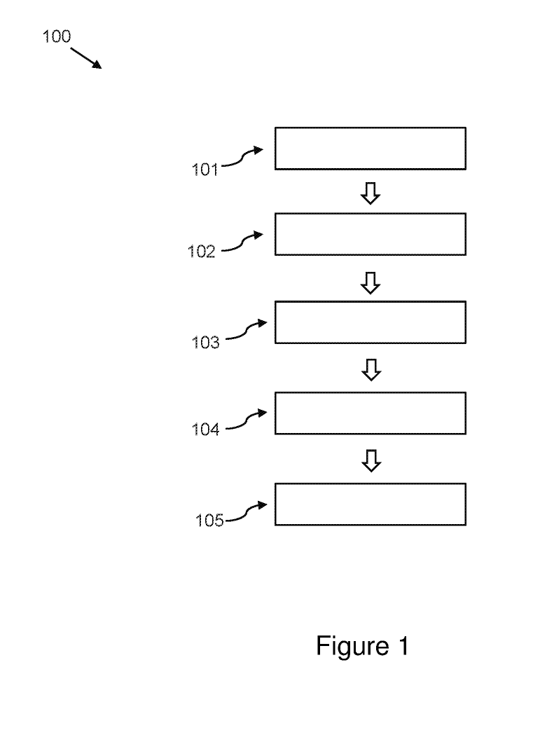

FIG. 1 shows a flowchart for an embodiment of the method for implementing and attaching at least one structure-integrated optical waveguide into a laminate component. In step 101, at least one optical waveguide is introduced during a laying procedure of a laminate for producing a preform (or blank) of a laminate component. In step 102, the position of the at least one optical waveguide in the preform is stored. In step 103, the laminate component is finished, wherein the optical waveguide is completely enclosed by the laminate. In step 104, at least one end of the optical waveguide is exposed. In step 105, a coupling component is attached to the prepared end of the optical waveguide.

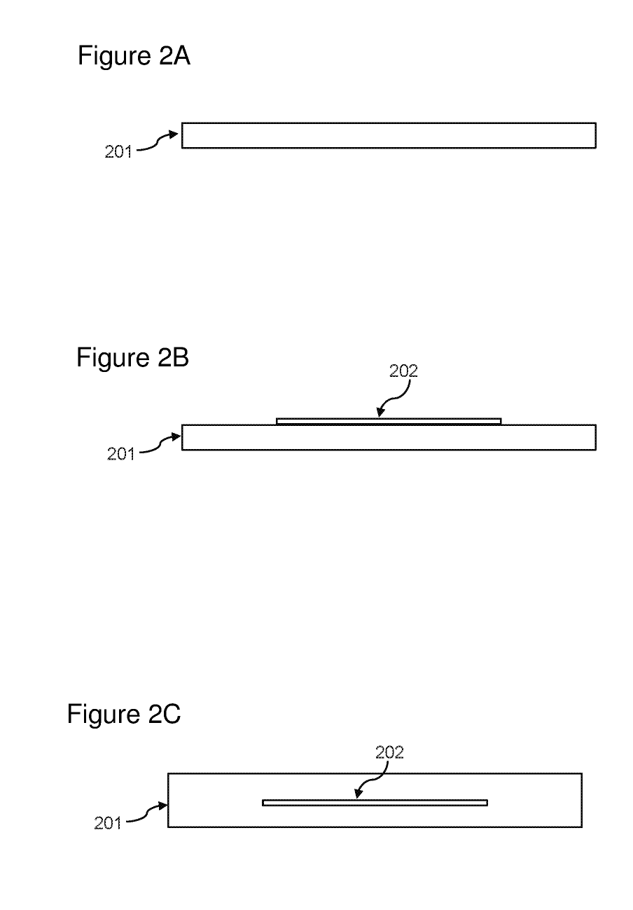

FIGS. 2A through 2F show the individual method steps of the method for implementing and attaching at least one structure-integrated optical waveguide in a laminate component in detail.

In the method step shown in FIG. 2A, a part of a preform of a laminate component is produced. In general, a laminate component, for example, a composite component made of carbon fibers, consists of or comprises multiple layers, which are laid one on top of another during the production process or consist of or comprise woven carbon fiber mats. These carbon fiber mats are also called prepregs if they are already impregnated with resin or dry fabric or scrims if they are not already impregnated. In FIG. 2A, the laminate component 201 already comprises, for example, one or more plies, on which the optical waveguide 202 is applied in the next step, shown in FIG. 2B.

In the method step shown in FIG. 2B, an optical waveguide 202 is applied to the already produced part of the preform of the laminate component. During the laying of the individual layers or plies or the individual fibers (CFRP—Carbon Fiber Reinforced Polymers), at least one optical waveguide 202 is laid on and/or between the already laid carbon fiber mats or laid individual fibers at a predetermined position. On the basis of the predetermined position of the optical waveguide 202 in the later finished laminate component 201, it can be located as accurately as possible in the following steps.

In FIG. 2C, the laminate component 201 is finished. In general, after the laying of the carbon fiber mats or the completion of the laying of the individual fibers, respectively, a resin is introduced, which infiltrates into the intermediate spaces of the carbon fibers. In a subsequent method step, the laminate component is cured, for example, by heating. The optical waveguide 202 is completely enclosed by the laminate after completion of the production of the laminate component 201.

In FIG. 2D, at least one end of the optical waveguide 202 is exposed. This can be performed mechanically, for example, by drilling or milling. In this case, on the basis of the predetermined and stored position of the optical waveguide 202 in the laminate component 201, as shown in FIG. 2B, an opening 204, for example, is created in the region of one end of the optical waveguide 202. In one embodiment (not shown), further openings can also be produced, for example, at the second end of the optical waveguide or in an intermediate region.

In FIG. 2E, the exposed end of the optical waveguide 202 is prepared, for example, by a polishing unit 205. The preparation of the exposed end of the optical waveguide 202 can also be carried out, for example, by other methods (not shown).

In FIG. 2F, a coupling component 206 is attached to the prepared end of the optical waveguide 202. The coupling component 206 is fixed in a further method step (not shown) on the laminate component 201, for example, by a screw connection, clamping, or adhesive bonding.

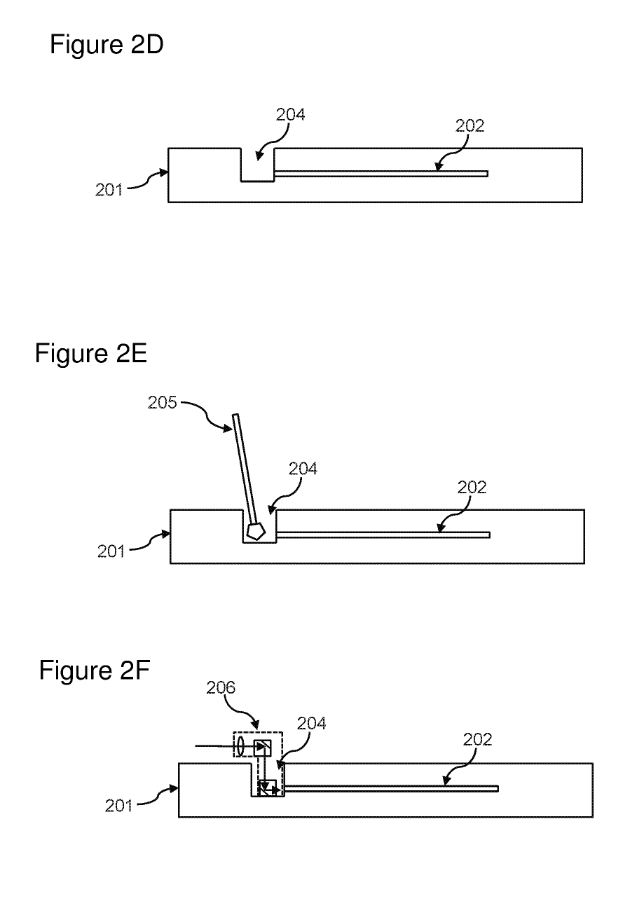

FIG. 3 shows an embodiment of a laminate component 301 having integrated optical waveguide 302. The optical waveguide 302 is completely enclosed by the laminate component 301. In the illustrated embodiment, one end of the optical waveguide 302 is exposed by an opening 303 in the laminate component 301. A coupling component 306 is introduced into the opening 303. The coupling component 306 has two mirrors 307, 307′ and a lens 308 in the embodiment shown. A light beam can be introduced into the optical waveguide 302 by the lens 308 and the mirrors 307, 307′. The optical waveguide 302 can be, for example, a sensor fiber (not shown) in this case, with the aid of which twists in the laminate component 301 may be detected.

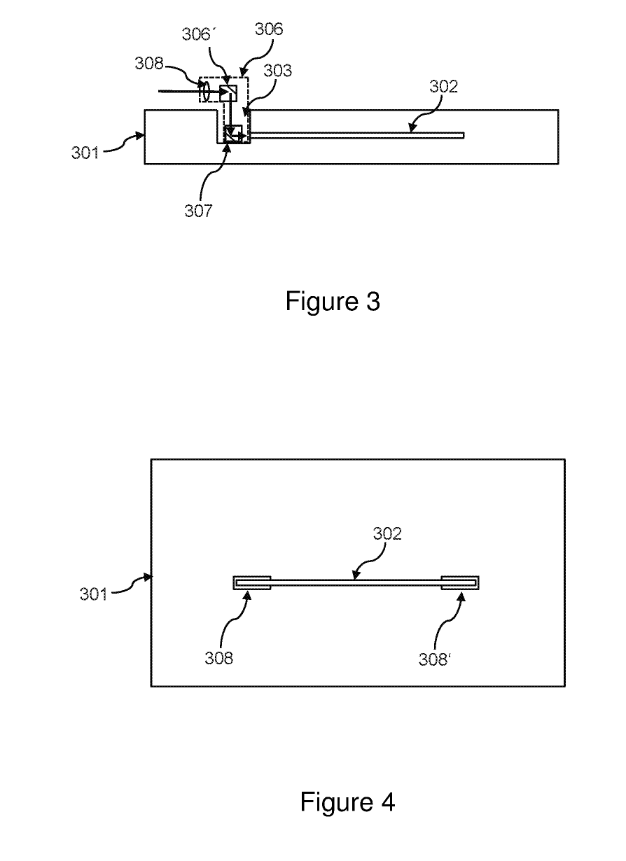

FIG. 4 shows a further embodiment of a laminate component 301 having integrated optical waveguide 302. The optical waveguide 302 is completely enclosed by the laminate component 301. In the illustrated embodiment, the two ends of the optical waveguide 302 are enclosed with a protective envelope 308, 308′. The protective envelope 308, 308′ is at least partially removed in the step for exposing the at least one end of the optical waveguide (see, for example, FIG. 2D). The removal of the protective envelope 308, 308′ can be performed, for example, by a laser (not shown). The ends of the optical waveguide 302 enveloped by the protective envelope 308, 308′ are linearly aligned in the illustrated embodiment. In a further embodiment (not shown), the ends can also be rolled, looped, or provided in another form and enclosed by a protective envelope. In a further embodiment (not shown), the optical waveguide can also be enclosed over the entire length by a protective envelope.

Although the disclosure herein has been shown and described above all with reference to specific embodiments, it should be understood by those skilled in the relevant technical field that numerous changes with respect to design and details can be performed thereon without deviating from the essence and scope of the disclosure herein as defined by the appended claims. The scope of the disclosure herein is thus defined by the appended claims and it is therefore intended that it comprise all changes which fall under the meaning or the scope of equivalence of the claims.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a”, “an” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

### LIST OF REFERENCE SIGNS

100 method
101-106 method steps
201, 301 laminate component
202, 302 optical waveguide
204, 304 opening
205 polishing unit
206, 306 coupling component
307, 307′ mirror
308 lens

1. A method for implementing and attaching at least one structure-integrated optical waveguide in a laminate, the method comprising:
introducing at least one optical waveguide at a predetermined position during a lamination of a laminate to produce a laminate component;
finishing the laminate component, wherein the optical waveguide is completely enclosed by the laminate;
exposing at least one end of the optical waveguide; and
attaching a coupling component to the at least one exposed end of the optical waveguide.

2. The method according to claim 1, wherein exposing at least one end of the optical waveguide is performed by laser, drilling, or milling.

3. The method according to claim 1, wherein the at least one end of the optical waveguide is enclosed by a protective envelope, which is at least partially opened or removed after exposing of the at least one end.

4. The method according to claim 1, wherein the exposed end of the optical waveguide is prepared.

5. The method according to claim 4, wherein preparing the end of the optical waveguide comprises polishing or grinding.

6. The method according to claim 1, wherein the coupling component is configured to conduct a light beam introduced into the end of the optical waveguide into and/or a light beam guided out of the end of the optical waveguide out of the laminate component.

7. The method according to claim 6, wherein the coupling component is configured to change a shape of the light beam by beam shaping.

8. The method according to claim 1, wherein the coupling component is fixedly connected to the laminate component.

9. The method according to claim 8, wherein the coupling component is fixedly connected to the laminate component by a screw connection, clamping, and/or adhesive bonding.

10. The method according to claim 1, wherein the predetermined position of the at least one optical waveguide comprises orientation of the optical waveguide in the laminate component.

11. The method according to claim 1, further comprising attaching a connecting element to the coupling component.

12. The method according to claim 11, wherein the connecting element is an optical plug and/or wherein the connecting element has a device for widening a light beam.

13. The method according to claim 1, wherein the optical waveguide is a sensor and/or communication fiber.

14. The method according to claim 1, wherein the optical waveguide has a fiber Bragg grating, which forms a mechanical and/or optical sensor.

15. A laminate component comprising:
at least one optical waveguide;
wherein the optical waveguide is completely embedded in the laminate component;
at least one coupling component which is connected to at least one exposed end of the at least one optical waveguide; and
wherein the coupling component is fixedly connected to the laminate component.
